(19) United States
(12) Patent Application Publication
(10) Pub. No.: US 2006/0176699 A1
(43) Pub. Date: Aug. 10, 2006

(54) Fluid cooling lighting system

(76) Inventor: Paul David Crunk, Taylor, MI (US)

Correspondence Address: Paul Crunk;12220 Woodcrest, Box 725, Taylor, MI, 48180, US

(21) Appl. No.: 11/053,618

(22) Filed: Feb. 8, 2005

(51) Int. Cl. F21V 29/00

(52) U.S. Cl. 362/294

(57) ABSTRACT

A colorless, odorless, non corrosive, non conductive fluid, non toxic, environmentally safe available in different boiling points and freeze points, which will not burn and will be used for all types of lighting sources for purpose of anti freeze (to not freeze) and cooling, to removing heat in all type lighting products, which will allow all types of lighting products to be pushed at much higher limits extending the life in all types of lighting. This fluid type of lights can be used in home, business, auto, motorcycle, truck, trailer and can be LED, Fluorescent or other forms of lighting, which there components and lighting elements needs to be cooled extending the life and allow the light to be operated at far above the normal setting achieving the maximum output possible making the light fire resistant when using this non flammable fluid to produce wide intense super bright light generation for greater illumination. The lighting product can be self contained or in different components linked together that can utilize this fluid to cool the ballast, component and light generation source internal or external.

### BACKGROUND OF INVENTION

To this present-day with all types lighting products there is a heat factor to always consider when using incandescent, florescent, LED lighting and there related components, which creates heat, wears out and can also prevents the maximum performance or output that could be achieved by each lighting source. There are many ways to achieve a cooling process, but in the past it has been inadequate or because of being corrosive, flammable, explosive, toxic or being able to conduct electricity shorting out the circuit, components or light source, when using other forms of liquid cooling which makes direct contact with component or the lighting source. There is now a liquid that can achieve the cooling without compromising the circuit board, components wiring or lighting element in all types of lighting products used in vehicles, residential or commercial applications.

### BRIEF SUMMARY OF THE INVENTION

The present invention provides the most advanced way of liquid cooling of all types lighting products and electrical components, wiring, PCB, case or lens used as part or within a lighting system, which includes light bulbs, floodlight, fluorescent lamp, LED (light emitting diode) and other low or high output lights that provides light to any living thing or machine to see or use.

### BRIEF DESCRIPTION OF THE DRAWINGS

FIG. 1. Shows one type of lighting source regarded as an LED light/lamp containing a lens, bottom case PCB, baffle reflect reflector some times used, LEDs mounted to a PCB that produce the light and other electrical component not shown that mount to the PCB and many other LEDs not shown that attached to the LED PCB. This fluid will now be able flow and surround the LED and PCB and components not shown to extract the heat being generated allowing everything to operate at its most efficient and coolest temperature for maximum performance and light output where before the heat would build up in the PCB, Components now show and LEDs that would cause imminent LED failure due to over heating. The fluid can also disburse the light in all direction for a much brighter wider light glow and transmit the heat to the LENS and CASE removing the heat to the outside of the lamp. This fluid can be used to cool certain parts of the light or completely fill the light or lamp fully for maximum cooling and protection against fire or overheating.

FIG. 2. Shows a example of a florescent light source with case, lens, tube reflector and ballast, reflector, which produces greater heat build up that is more of a fire hazard then other low power lights like LED lighting. There is a fluid that can be used to cool the ballasts and the fluorescent tube, reflector, wires and component not shown which also generates greater heat, which now be cooled down with this fluid extending the life of the components and lighting element and can also help disburse the light output in all directions for a much brighter wider light disbursement and also transmit the heat to the LENS and CASE removing the heat to the outside of the light/lamp in any size or shape, which including light bulbs. This fluid can be used to cool certain parts of the light or completely fill the light or lamp fully for maximum cooling and protection against fire or overheating.

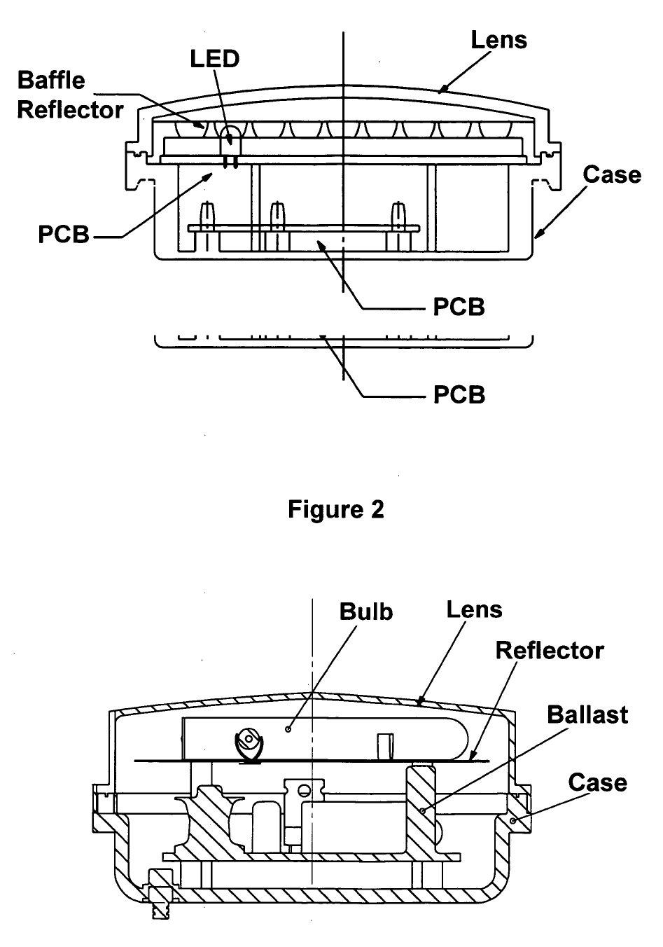

### DETAILED DESCRIPTION OF THE INVENTION

The present invention provides a liquid source called Galgen, a Chemical name; Propene, 1,1,2,3,3,3-hexafluoro, oxidized, polymerized Chemical family: Fluorocarbon, Prefluorinated polyethers, which is clear, colorless liquid, insoluble, compatibility (inert) high thermal stability, dielectric (non conductive), low viscosity at low temperatures, non-flammable, environmentally safe, good radiation resistance, heat transfer fluid that will not freeze or boil past it set boiling point to be used to preventing freezing and used as a cooling process in keeping the components and lighting elements cool by extracting the heat away preventing electrical component failure and extending the life of the electrical components and lighting element/s. This will also allow the lighting source to be able to be pushed at much higher limits or intensity without the risk of failures or fire. The Fluid comes in different temperatures and freeze points and is non flammable, non explosive, non toxic, environmentally safe and will not freeze below zero and will not boil before it boiling point. The fluid is also good to transmit light in a much wider glow allowing the light to disburse in much wider viewing angles and take the heat to the outside of the light or lamp through the case or heat sink used in some current types lighting

What is claimed:

1. A colorless, odorless, non corrosive, non conductive fluid, non toxic, environmentally safe and available in different boiling points and freeze points to be used as part of lighting applications for the purpose of cooling and removing heat generated with lighting, which will not freeze and extend the life of lighting.

2. A colorless, odorless, non corrosive, non conductive fluid, non toxic, environmentally safe available in different boiling points and freeze points by submersing high or low voltage components associated as part of lighting products for the purpose of removing heat generation and prolonging the life of all components and lighting element.

3. A colorless, odorless, non corrosive, non conductive fluid, non toxic, environmentally safe available in different boiling points and freeze points submersing the light emitting diodes and PCB for the purpose of removing heat and cooling components internal and external to prevent circuit board and LED failure in low power lighting.

4. A colorless, odorless, non corrosive, non conductive fluid, non toxic, environmentally safe available in different boiling points and freeze points which is non flammable for the purpose of cooling the components internal and external and removing heat and extending life of all types of high power lighting.

5. A colorless, odorless, non corrosive, non conductive fluid, non toxic, environmentally safe available in different boiling points and freeze points, which will not burn to be used in all lighting for purpose of cooling, removing heat in lighting, which will allow all types of lighting to be pushed at much higher limits without compromising the components or light element/s through the use of submersing with fluid.

6. A colorless, odorless, non corrosive, non conductive fluid, non toxic, environmentally safe available in different boiling points and freeze points, which will not burn which will be used in all types of lighting for purpose of cooling and removing heat in lighting, which will allow all types of lighting to be pushed at much higher limits of light output, which will disburse the heat and light through the fluid spreading the light out in a much wider angle of viewing and taking the heat to the outside of the light through the case, lens or heat sink used in some lights easily conducts heat and can remove the heat away from the components to the outside of the light.
